(19) United States
(12) Patent Application Publication
(10) Pub. No.: US 2006/0060244 A1
(43) Pub. Date: Mar. 23, 2006

(54) Fuel cell manifold

(76) Inventors: Shawn D. Eggum, Lonsdale, MN (US); Michael W. Johnson, St. Louis Park, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/208,019

(22) Filed: Aug. 19, 2005

Related U.S. Application Data
(60) Provisional application No. 60/603,300, filed on Aug. 20, 2004.

(51) Int. Cl. H01M 2/02; B65B 43/42; E03B 11/00; F03B 11/02

(52) U.S. Cl. 137/263; 429/34; 137/561 R; 141/181

(57) ABSTRACT

A manifold for a fuel cell includes at least one floating manifold port disposable in an oversized opening defined in a manifold frame, the manifold port being shiftable in at least one plane relative to the oversized opening for reducing the positional tolerance requirement of the manifold port, thereby effecting enhanced mating of adjacent fuel cell components. A method of forming a manifold for a fuel cell is further included.

### RELATED APPLICATION

The present application claims the benefit of U.S. Provisional Application Ser. No. 60/603,300, filed Aug. 20, 2004, included herein in its entirety by reference.

### FIELD OF THE INVENTION

The invention pertains to an electrochemical cell, and in particular to an electrochemical cell comprising a manifold with positionable ports.

### BACKGROUND OF THE INVENTION

In general, a fuel cell is an electrochemical device that can convent energy stored in fuels such as hydrogen, methanol and the like, into electricity without combustion of the fuel. A fuel cell generally comprises a negative electrode, a positive electrode, and a separator within an appropriate container. Fuel cells operate by utilizing chemical reactions that occur at each electrode. In general, electrons are generated at one electrode and flow through an external circuit to the other electrode to balance the chemical reactions. This flow of electrons creates an over-voltage between the two electrodes that can be used to drive useful work in the external circuit. In commercial embodiments, several “fuel cells” are usually arranged in series, or stacked, in order to create larger over-potentials.

A fuel cell is similar to a battery in that both generally have a positive electrode, a negative electrode and electrolytes. However, a fuel cell is different from a battery in the sense that the fuel in a fuel cell can be replaced without disassembling the cell to keep the cell operating. Additionally, fuel cells have several advantages over other sources of power that make them attractive alternatives to traditional energy sources. Specifically, fuel cells are environmentally friendly, efficient and utilize convenient fuel sources, for example, hydrogen or methanol.

As noted above, the fuel in a fuel cell can be replaced without disassembling the cell. Generally, the fuel in a fuel cell is a fluid such as, for example, hydrogen gas, which is pumped or circulated to the anode, while an oxidizing agent, such as air (oxygen), is delivered to the cathode. Additionally, reaction products are generally removed from the system. The delivery of appropriate reactants to the anode and the cathode, as well as the removal of reaction products, introduce specific fluid flow issues.

Fuel cells have potential uses in a number of commercial applications and industries. For example, fuel cells are being developed that can provide sufficient power to meet the energy demands of a single family home. In addition, prototype cars have been developed that run off of energy derived from fuel cells. Furthermore, fuel cells can be used to power portable electronic devices such as computers, phones, video projection equipment and the like. Fuel cell systems are generally described in U.S. Pat. No. 6,565,998, entitled “Direct methanol fuel cell system with a device for the separation of the methanol and water mixture,” U.S. Pat. No. 6,544,677, entitled “Fuel cell system,” and U.S. Pat. No. 6,475,655, entitled “Fuel cell system with hydrogen gas separation,” all of which are hereby incorporated by reference herein.

### SUMMARY OF THE INVENTION

In a first embodiment, the invention pertains to an electrochemical cell comprising an anode, a cathode and an electrolyte in contact with the anode and the cathode. In these embodiments, the electrochemical cell can further comprise a flow network comprising a manifold frame having at least one manifold port, the manifold port comprising a port body with a bore that forms a channel through the port body wherein the manifold port can move in at least one dimension relative to the manifold frame.

In a second embodiment, the invention pertains to an electrochemical cell comprising an anode, a cathode and an electrolyte in contact with the anode and the cathode. In these embodiments, the electrochemical cell can further comprise a flow network comprising a manifold structure having a manifold frame and at least one manifold port, the manifold port comprising a port body with a bore that forms an opening through the port body and a protrusion that extends outwardly from the port body, the protrusion engaging a groove on the manifold frame wherein the manifold port can move relative to the manifold frame when the manifold is disengaged from the electrochemical cell.

In a third embodiment, the invention relates to an electrochemical cell comprising an anode, a cathode, and an electrolyte in contact with the anode and the cathode. In these embodiments, the electrochemical cell can further comprise a flow network comprising a manifold frame having a manifold port connected to a flow tube, wherein the flow tube is composed of a composite comprising a polymer and a conductive additive. In some embodiments, the composite can comprise PVDF and carbon powders and/or carbon fibers.

In another aspect, the invention pertains to an electrochemical cell comprising an anode, a cathode and an electrolyte in contact with the anode and the cathode. In these embodiments, the electrochemical cell can further comprise a manifold frame having a manifold port, the manifold port comprising a port body with a bore that forms a channel through the manifold port and a baffle located within the bore to provide a more uniform fluid flow through the opening of the port relative to corresponding flow through an equivalent bore without the baffle.

In a further aspect, the invention pertains to a method of assembling a fuel cell comprising adjusting a manifold port on a manifold structure to engage a corresponding port in fluid communication with a fuel cell stack, wherein the manifold port and the corresponding port define a fluid flow path when engaged, and wherein the manifold port is adjusted by moving the manifold port relative to a manifold frame that supports other manifold elements.

In another embodiment, the invention pertains to a vehicle comprising an electrochemical cell stack and at least one manifold as described herein operably connected to the electrochemical cell stack.

The present invention includes in one embodiment at least one floating port. The floating port design allows for an easily effected plug-in connection between fuel cell components, such as a fuel cell stack and a manifold. This means of connection greatly reduces the number of fasteners required, as compared to the prior art face seal connection. Further, this means of connection greatly reduces the positional tolerance requirements of the ports as compared to the prior art radial seal joints.

The present invention further includes in one embodiment at least one fluid diffuser or baffle disposed in a port. Such baffle (diffuser) acts to provide an even dispersion of fluid to a cell stack through the relatively large oval port. Fluid is typically supplied by a round hose to the port, concentrating the fluid flow toward the center of the port and providing diminished flow at both edges of the port. The baffle provides for even fluid flow across the full-length dimension of the port.

The present invention includes in one embodiment, at least one over molded port connection. The outer body of the port is preferably formed of a metal, preferably stainless steel. The inner portion of the port, that portion in contact with the fluid being transported, is then formed of a material that is impervious to the fluid, preferably a plastic material such as PVDF. The plastic material is preferably injection molded around portions of the metallic body. All surfaces that contact the fluid media are then formed of impervious plastic material, while the metallic body provides the structural strength to withstand a known burst pressure (typically, 414 kpa). Further, the metallic frame may be formed with integral mounting pins for effecting the mating of fuel cell components.

The present invention is a manifold for a fuel cell, including at least one floating manifold port disposable in an oversized opening defined in a manifold frame, the manifold port being shiftable in at least one plane relative to the oversized opening for reducing the positional tolerance requirement of the manifold port, thereby effecting enhanced mating of adjacent fuel cell components. The present invention is further a method of forming a manifold for a fuel cell.

### BRIEF DESCRIPTION OF THE FIGURES

FIG. 1 is a top view of a manifold having a plurality of floating or moving manifold ports.

FIG. 2 is a top perspective view of the manifold of FIG. 1.

FIG. 3 is a bottom perspective view of the manifold of FIG. 1 rotated 90 degrees to show flow tubes that can be connected to the manifold ports, with a cell stack shown connected to the manifold in dashed lines.

FIG. 4 is a cross-sectional view of the manifold of FIG. 1, the cross-section taken along line c-c of FIG. 1.

FIG. 5a is an enlarged view of the circled portion of FIG. 4 showing a groove located inside an opening in a manifold body engaged with a protrusion on the port located within the opening.

FIG. 5b is a cross-sectional view of the manifold of FIG. 1, the cross-section taken along line d-d.

FIG. 5c is an enlarged view of the circled portion of FIG. 5b showing a groove located inside an opening in a manifold body engaged with a protrusion on the port located within the opening.

FIG. 6 is a cross-section view of an alternate coupling mechanism that facilitates a floating or moving manifold port.

FIG. 7 is a top view of a port that can be employed in the manifolds of the present disclosure.

FIG. 8 is a bottom view of the port of FIG. 7.

FIG. 9 is a top perspective photo of a manifold of the present disclosure.

FIG. 10 is a bottom perspective photo of the manifold of FIG. 9.

FIG. 11 is side photo of the manifold of FIG. 9.

FIG. 12 is a schematic diagram of a cell stack interfaced with a manifold that is connected to a hydrogen source, an oxygen source and a coolant source.

FIG. 13a is a frontal sectional view of a manifold port with baffle taken along section line A-A of FIG. 13a.

FIG. 13b is a side sectional view of a manifold port with baffle taken along section line B-B of FIG. 13a.

FIG. 13c is a top view of a manifold port with baffle.

FIG. 14 is a perspective sectional view of an overmolded manifold port with baffle.

FIG. 15 is a section view of a manifold with pin connectors connecting the port to the manifold frame.

FIG. 16a is perspective view of manifold channel ports mated to a manifold frame using snap fingers.

FIG. 16b is a sectional view taken along section line A-A of FIG. 16a of the manifold channel port mated to the manifold frame using snap fingers.

### DETAILED DESCRIPTION OF THE INVENTION

Electrochemical cells comprise an anode, a cathode, an electrolyte in contact with the anode and the cathode, and a flow network comprising a manifold structure having at least one manifold port adapted to engage a corresponding port on the electrochemical cell such that a fluid flow pathway from the manifold port to the corresponding port of the electrochemical cell can be established. In improved embodiments described herein, the manifold port is connected to a frame of the manifold such that the manifold port can move, or float, in at least one direction when not engaged with the electrochemical cell. In some embodiments, the manifold port can comprise structure that engages with a mated structure on the manifold frame such that the manifold port can move over a limited range in at least one dimension relative to the manifold frame while being supported by the manifold frame. Due to the presence of the moving or floating manifold port, the manifold structure can more easily engage and disengage with other components of the electrochemical cell. Moreover, in embodiments where the manifold comprises a plurality of manifold ports, the floating ability of each port can facilitate easy engagement with a plurality of corresponding ports, and can increase the manufacturing tolerances of the manifolds. In some embodiments, each of the plurality of manifold ports can independently float or move, relative to the other manifold ports, which can facilitate coupling each of the ports to a corresponding port. In some embodiments, one or more baffles can be positioned within the fluid channels defined in the manifold ports to facilitate substantially uniform fluid flow out of manifold ports.

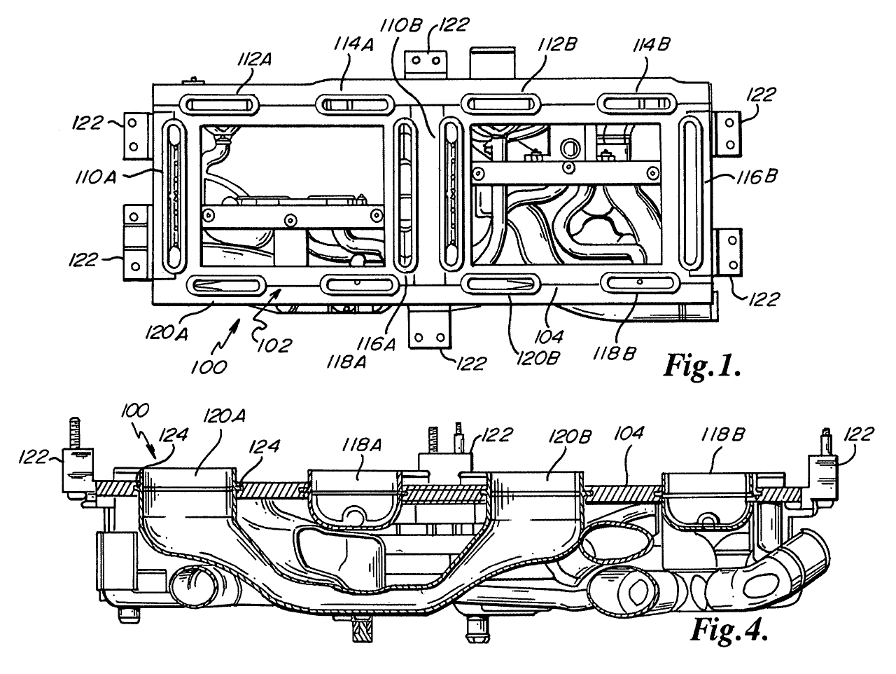

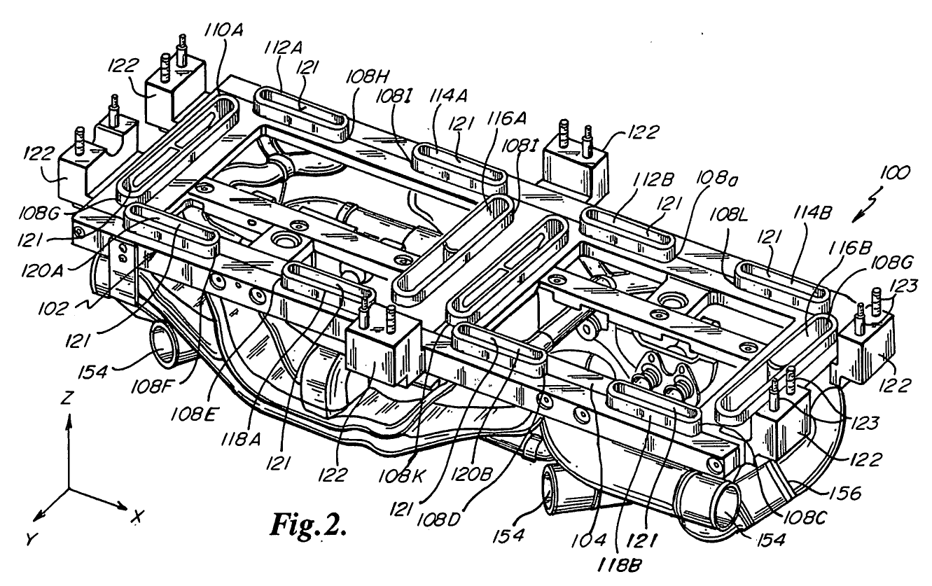

Referring to FIGS. 1-3, a manifold 100 is shown comprising manifold frame 102. Manifold frame 102 can include a top face 104 and an opposed bottom face 106. Generally, manifold frame 102 can be provided with one or more openings 108a-l, wherein each opening defines a passage though manifold frame 102. In some embodiments as depicted in FIG. 2, a manifold port 110 can be positioned within each opening 108a-l, and thus the size and shape of each opening can be guided by the corresponding size and shape of the manifold port 110 (in the description, a manifold port is generically noted by the reference numeral 110, although other reference numerals are used to denote manifold ports of differing design) adapted to fit into the specific opening 108. In some embodiments, the plurality of openings 108a-j can have substantially the same size and shape, while in other embodiments the plurality of openings 108a-l can have different sizes and shapes from each other. Referring to FIG. 2, twelve openings 108 are shown with four, openings 108 b, g, j, and k, having a common size and shape and the other eight, openings 108 a, c, d-f, h, i, and l, having a common size and shape.

As shown in the embodiment of FIGS. 1-3, manifold 100 can comprise a plurality of manifold ports 110a, 110b, 112a, 112b, 114a, 114b, 116a, 116b, 118a, 118b, 120a and 120b, each of the manifold ports 110a, 110b, 112a, 112b, 114a, 114b, 116a, 116b, 118a, 118b, 120a positioned within a respective one of the openings 108a-l in manifold frame 102. As shown in FIG. 2, the openings 121 of each of the manifold ports 110a, 110b, 112a, 112b, 114a, 114b, 116a, 116b, 118a, 118b, 120a can all be aligned in substantially the same direction (the Z direction in the depiction of FIG. 2) to facilitate quick connection to a cell stack endplate or another electrochemical cell component. Although FIGS. 1-3 shown an embodiment where twelve manifold ports 110a, 110b, 112a, 112b, 114a, 114b, 116a, 116b, 118a, 118b, 120a are provided in manifold 100, one of ordinary skill in the art will recognize that manifolds with different numbers of manifold ports, e.g., greater or smaller than twelve, are contemplated and are within the disclosure. Additionally, the number of manifold ports in a particular manifold can be guided by the corresponding design of the electrochemical cell stack that the manifold is designed connect with. As described below, each manifold port is generally connected to one or more flow pipes 154 to facilitate moving desired fluids through the respective manifold port 110a, 110b, 112a, 112b, 114a, 114b, 116a, 116b, 118a, 118b, 120a.

Manifold frame 102 can further comprise one or more fastening structures 122 positioned, for example, around the periphery of manifold frame 102 to facilitate connecting manifold frame 102 to another electrochemical cell structure such as, for example, a cell stack endplate, a mounting bracket or the like. Upward directed threaded studs 123 are included to help facilitate connecting manifold frame 102 to another electrochemical cell structure. The manifold shown in FIGS. 1-3 is designed to couple to two cell stacks. One of ordinary skill in the art will recognize that the manifold 100 could be adapted to couple to a different number cell stacks with a corresponding change in manifold design.

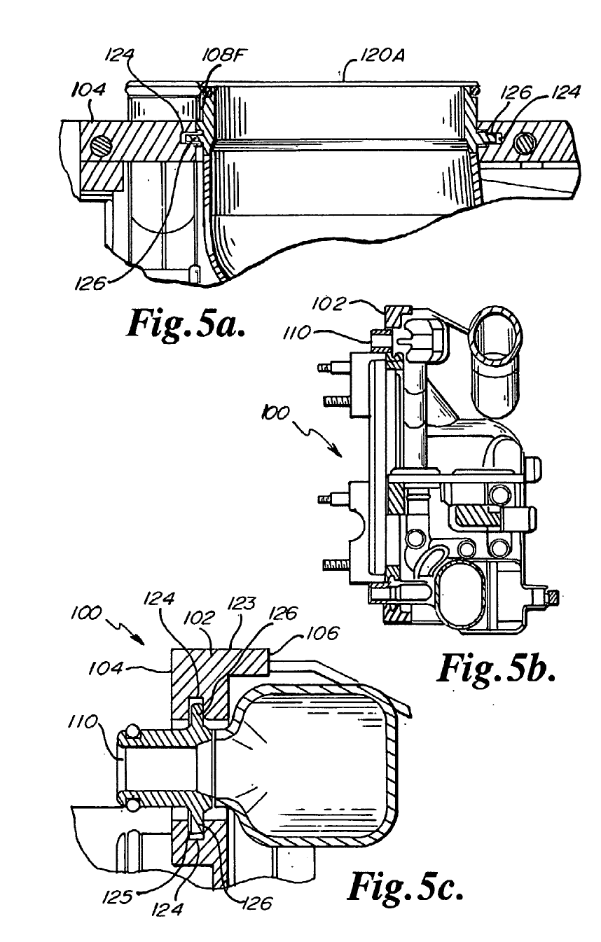

Generally, manifold frame 102 provides support for the manifold ports, and connected flow tubes, and also provides structure that can secure the manifold to electrochemical cell components. As shown in FIG. 5a, in some embodiments, each of the plurality of openings 108a-l in the manifold frame 102 can have a peripheral groove or channel 124 that extends along edges of the opening 108a-l. For example, as shown in FIG. 5a, which is an enlarged view of the encircled portion of FIG. 4, groove 124 can be located within opening 108f and can be adapted to engage a corresponding rim or tongue 126 on port 120a, which permits port 120a to move, or float, in at least one dimension (e.g., in the xy plane, as depicted in FIG. 2) while positioned in opening 108f. The rim 1226 outer margin 123 is spaced apart from the groove 124 inner margin 125. The height dimension of the rim 124 may be less than the height dimension of the groove 124 such that there is spacing for float in the Z direction as well. This spacing is apparent in FIG. 5a. Thus, during engagement of manifold port 120a with a corresponding port located on an electrochemical cell component, manifold port 120a can move or float at least laterally in the XY directions, which can facilitate easier alignment and connection.

The floating engagement of a manifold port with an opening in a manifold frame is also shown in FIGS. 5b and 5c. In some embodiments, each manifold port in a first component can float or move independently of the other manifold ports, which facilitates aligning a plurality of manifold ports with a plurality of corresponding ports in a second component, the second component to be mated to the first component. As noted above, in some embodiments, the manifold ports can float in the x-y axis from about ¼ of an inch to about 1/16 of an inch. In some embodiments, the manifold ports, such as manifold port 120a, can float, or move, in the z-axis. Such movement is typically about 1/32 of an inch or less. Additionally, in some embodiments, the manifold ports 120a can float in the x-y axis from about 2 to about 6 times the distance that manifold ports 120a can float in the z-axis. However, in other embodiments, two or more manifold ports 120a may be connected to a common flow tube 154. In these embodiments, desired levels of independent manifold port movement can be maintained by employing of a flexible and/or elastomeric flow tube material that will permit the coupled ports to move relative to one another.

Referring to FIG. 15, a third way of generating the float noted above is depicted. In this case the manifold frame 102 of the manifold 100 has an oversized bore 170 defined therein. As noted, the bore is preferably 0.375 inch in diameter. The manifold port 110 has an upward directed pin 172 that is disposable in the bore 170. As noted, the pin 152 preferably has a diameter of 0.250 inch. Accordingly, the pin 172 is free to float in the XY plane within the oversize bore 170. It should be noted that in this embodiment, the mating to the manifold port 110 to the frame 102 in the Z direction is preferably relatively snug, as indicated by the dimension noted at 176, wherein clearance is preferably 0.005-0.010 inch. It should be noted that other dimensions of the bore 170 and the pin 172 could be used as desired, depending on the application, in order to achieve the desired float in both the XY plane and in the Z direction.

Turning to FIGS. 16a and 16b, a further means of generating float is depicted. In this case, a peripheral frame 400 supports a frame plate 402. The frame 400 is disposable in the manifold 100. An opening 404 is defined in the frame plate 402 for each manifold channel port 408 to be mated to the plate 402. The opening 404 is surrounded by a plurality of peripheral snap fingers 410. The snap fingers 410 are formed of a resilient material and are spreadable with the snap fingers 410 snapping back to an original disposition after a spreading influence is removed.

The channel port 408 has a ridge 412 and a spaced apart outward directed lip 414. In assembly, channel port 408 is pressed into the opening 404 from the underside. The snap fingers 410 are forcibly spread by the channel port 408. The channel port 408 need not be perfectly aligned with the opening 404, since the snap fingers 410 may spread varying amounts by an off center channel port 408, thereby providing the desired amount of float. As the channel port 408 is fully inserted into the opening 404, the distal end of the snap fingers engage the ridge 412 and the proximal portion of the snap fingers 404 is supported upon the upper surface of the lip 412.

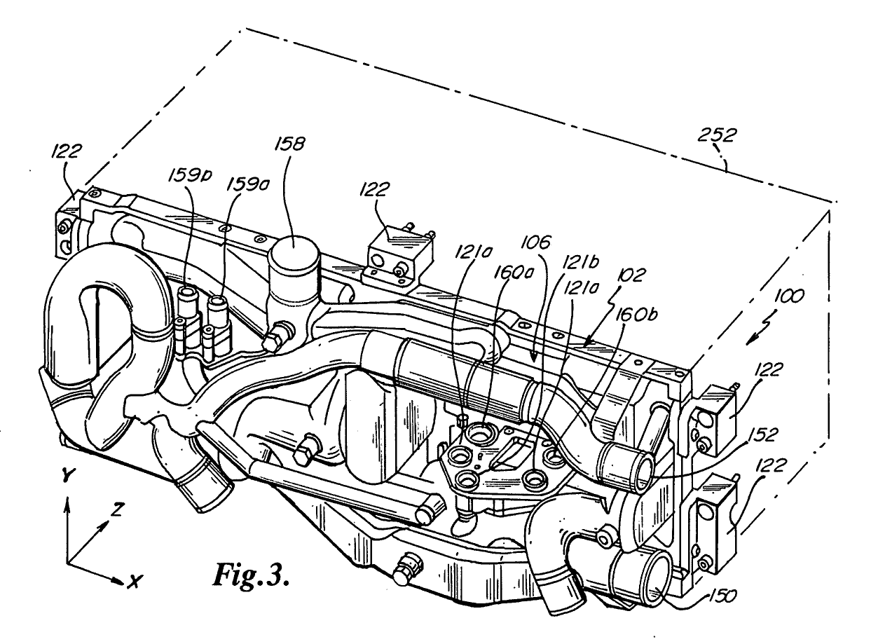

As shown in FIG. 3, manifold 100 can comprise ports 121a, 121b and 121c, which can be connected to, for example, an anode outlet unit or another electrochemical cell component. In some embodiments, ports 121a, 121b and 121c can be floating ports, having the rim and groove structures discussed above on the port 120a and opening to permit the ports to move in at least one dimension prior to engaging a corresponding port.

In some embodiments, manifold frame 102 can have a generally rectangular cross-section, although other shapes can be used as appropriate. Manifold frame 102 can be composed of any material suitable for use in electrochemical cell applications including metals, polymers and combinations thereof. Suitable metals include, for example, aluminum and stainless steel. Suitable polymers include, for example, poly(vinylchloride) (PVC), polyurethanes, polycarbonates, polyethylene (PE), ultra high molecular weight polyethylene (UHMWPE), poly(tetrafluoroethylene) (PTFE), polyetheretherketone (PEEK), and blends and copolymers thereof.

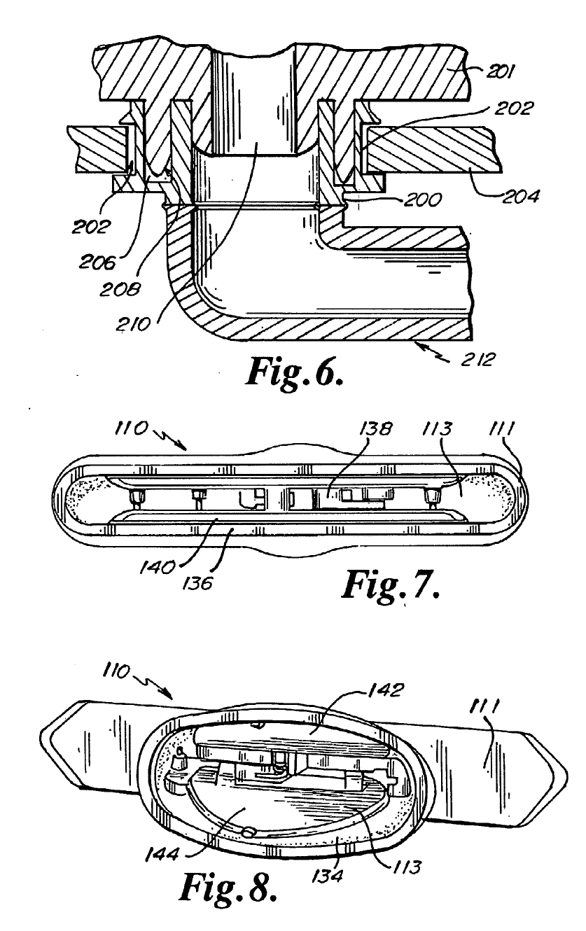

Referring to FIG. 6, an alternate coupling mechanism is shown that can permit a manifold port to float or move within an opening in a manifold frame. FIG. 6 shows a manifold port 200 coupled with a corresponding port 210 on a cell stack endplate 201. As shown in FIG. 6, manifold port 200 can comprise a channel 202 adapted to engage protrusion 204 on a manifold frame, which permits manifold port 200 to move in at least one dimension when not engaged with corresponding port 210. Additionally, port 200 can comprise slot 206 which can engage a corresponding protrusion 208 located on a cell stack endplate 201, which can roughly align port 200 with a corresponding port 210 during engagement. As shown in FIG. 6, manifold port 200 can be connected to a flow tube 212 to facilitate moving fluids to and from manifold port 200.

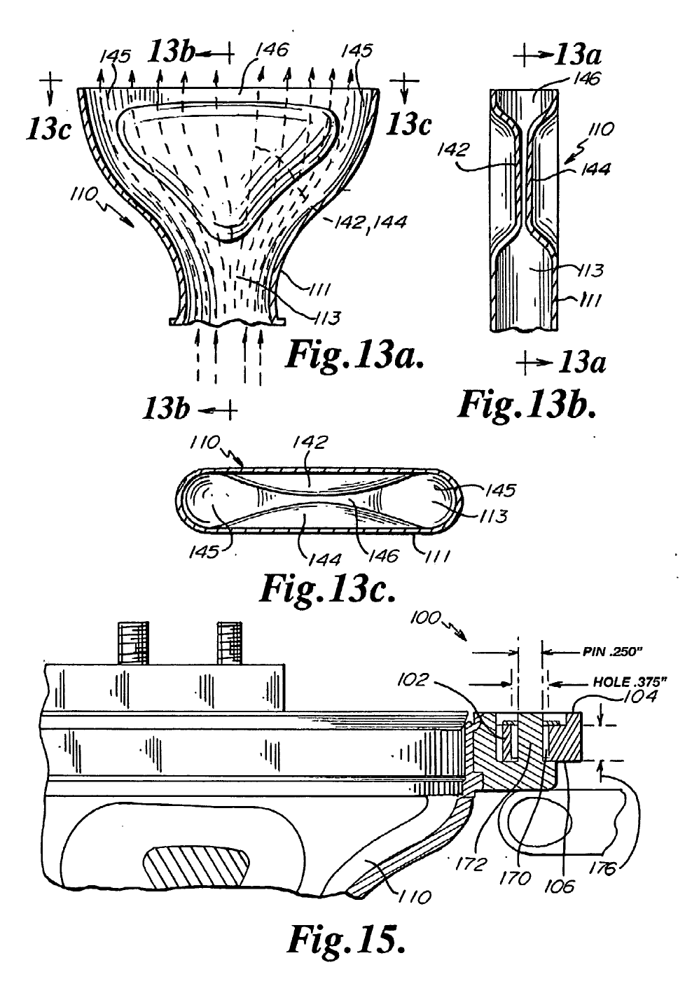

As described above, manifold 100 can comprise a plurality of manifold ports 110, which facilitate connecting manifold 100 to another electrochemical cell component such that a plurality of fluid flow paths between manifold 100 and another cell component are established. As depicted in FIGS. 13a-c and 14, generally, each manifold port 110 can comprise a port body 111 and a fluid channel 113 that is defined by and that extends though the port body 111. One end of the bore can be connected to a flow pipe, while the opposite end of the bore can form an opening adapted to engage with a corresponding port on another fuel cell component. Additionally, an o-ring 115 or the like can be positioned in a groove 119 defined in the port body 111 to facilitate sealing port 110 to a corresponding opening 108. In general, the o-ring can be composed of, for example, natural rubber, synthetic rubber, and the like and combinations thereof.

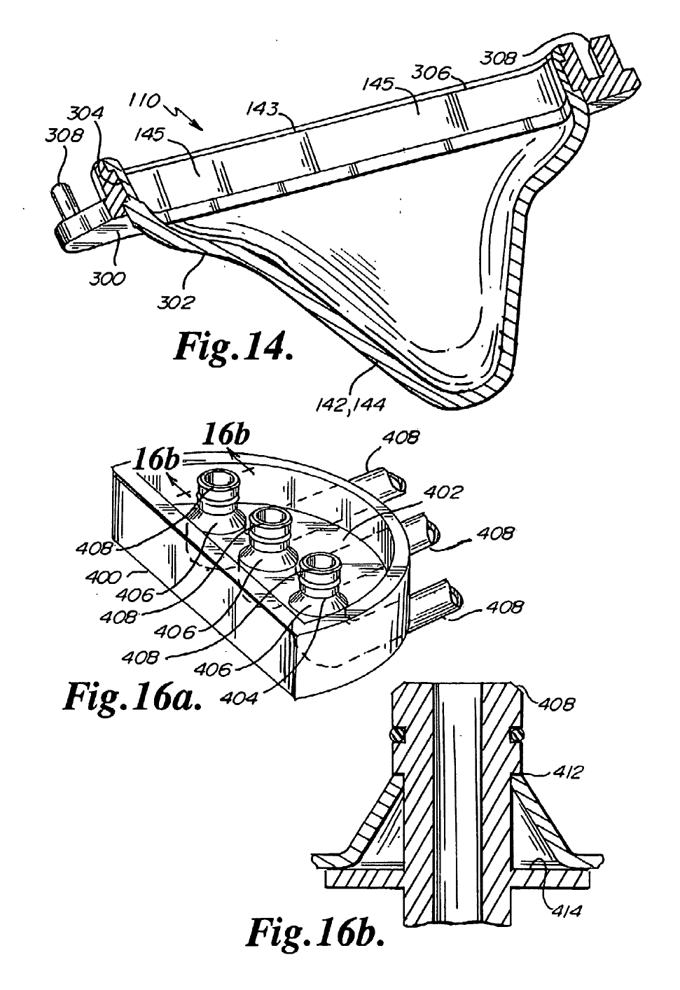

Referring to FIGS. 7 and 8, a manifold port 110 shown comprising port body 111 and fluid channel 113 extending through port body 111 such that fluid channel 113 defines a fluid flow pathway through port 110. In some embodiments, end 134 of port 129 can be adapted to engage with a fluid flow pipe, while opposed end 136 can be adapted to engage a corresponding port on another fuel cell component, such as a corresponding port on a fuel cell stack endplate. In some embodiments, one or more baffles 138, 140 (FIG. 7), 142, 144 (FIGS. 8, 13a-c, and 14) can be positioned within fluid channel 113 to alter the flow of fluids though fluid channel 113. Generally, the baffles 138, 140, 142, and 144 are designed to disperse fluid flow across the opening of fluid channel 113 such that a more uniform flow out of end 136 is achieved relative to corresponding flow without the baffle(s) 138, 140, 142, and 144 by restricting flow at the center 143 of the port 100 and forcing flow toward the outer edges 145 along the length of the port 110. See FIG. 14. One of ordinary skill in the art will recognize that the geometry and number of the baffle(s) employed in a particular manifold port 110 can be guided by the flow of incoming fluids and the desired flow streams for a particular electrochemical cell design.

The manifold ports 110 of the present disclosure can be comprised of any material suitable for use in electrochemical cell applications. Suitable materials include polymers such as, for example, polyethylene (PE), polypropylene (PP), poly(tetrafluoroethylene) (PTFE), poly(vinylidine diflouride) (PVDF), and blends and copolymers thereof. In addition, in embodiments where the manifold 100 is designed to be used with a hydrogen fuel cell, it can be desirable to reduce potential static build up in the manifold ports 110. In these embodiments, a conductive additive can be added to the polymer to form a composite material that can dissipate static. Suitable conductive materials include, for example, carbon powders, carbon fibers, carbon nanotubes, other carbon particles and combinations thereof. In some embodiments, the conductive additive/polymer composite can have a surface resistivity from about 10⁷ ohms/square to about 10⁹ ohms/square.

Generally, the manifold ports 110 of the present invention can be connected to one or more flow tubes, which can provide fluid flow pathways to each of the manifold ports 110. Referring to FIGS. 1-3, in some embodiments, flow tube 150 can be connected to manifold ports 120a and 120b, while flow tube 152 can be connected to manifold port 116a. In some embodiments, flow tube 154 can be connected to manifold port 110a, while flow tube 154 can be connected to manifold port 110b. Flow tube 156 can be connected to manifold port 116b, while flow tube 158 can be connected to manifold ports 114a and 114b. Flow tubes 159a and 159b can be connected to manifold ports 118a and 118b, respectively. Flow tubes 160a and 160b can be connected to manifold ports 112a and 112b, respectively. One or ordinary skill in the art will recognize that the connection of specific flow tubes to specific manifold ports can be guided by the design and fluid flow requirements of a particular electrochemical cell stack.

The flow tubes of the present disclosure can be formed from any material suitable for use in electrochemical cell applications. Suitable materials include, for example, polymers, copolymers, block copolymers and blends and copolymers thereof. Suitable polymers include, for example, polyethylene (PE), polypropylene (PP), poly(tetrafluoroethylene) (PTFE), poly(vinylidine diflouride) (PVDF), and blends and copolymers thereof. In addition, in embodiments where the manifold 100 is designed to be used with a hydrogen fuel cell, it can be desirable to reduce potential static build up in the flow tubes. In these embodiments, a conductive additive can be added to the polymer to form a composite material that can dissipate static. Suitable conductive materials include, for example, carbon powders, carbon fibers, carbon nanotubes, and combinations thereof. In some embodiments, the conductive additive/polymer composite can have a surface resistivity from about 10⁷ ohms/square to about 10⁹ ohms/square. In some embodiments, the flow tubes are formed by roto molding a composite comprising PVDF and carbon powder and/or carbon fibers. In these embodiments, in order to obtain a molded tube with a smooth surface, it is desirable to employ a composite material having a substantially spherical shape. In other words, roto molding a composite material comprising elongated particles can produce a molded article with undesirable surface features such as, for example, pits and/or grooves. In some embodiments, the length/diameter ratio of the composite material can be about 1:1, while in other embodiments the length to diameter ratio can be from about 1:1 to about 2:1. In some embodiments, the manifold ports can be injection molded and welded to the roto molded flow tubes to form the flow networks of the present disclosure. Roto molding is generally described in, for example, U.S. Pat. No. 4,629,409, entitled “Rotational molding apparatus having robot to open, close, charge and clean mold,” and U.S. Pat. No. 6,599,459, entitled “Method of rotational molding with moveable insert,” both of which are hereby incorporated by reference.

In some embodiments, during use of manifold 100, manifold ports 110a and 110b can be employed to supply air to the cathodes of an electrochemical cell, while manifold ports 118a and 118b can be employed to deliver hydrogen to the anodes. Additionally, manifold ports 116a and 116 can be used as cathode outlet ports, while manifold ports 112a and 112b can used as anode outlet ports. Manifold ports 120a and 120b can be used to supply coolant to an electrochemical cell stack, while manifold ports 114a and 114b can be used as coolant outlet ports. The flow tubes 152, 154, and 156, described above, can be used to supply appropriate fluids to the manifold ports of manifold 100.

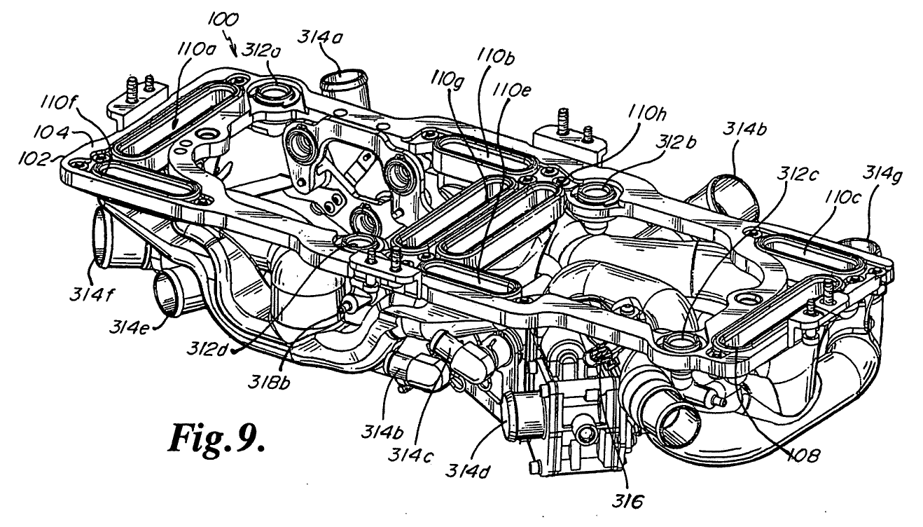

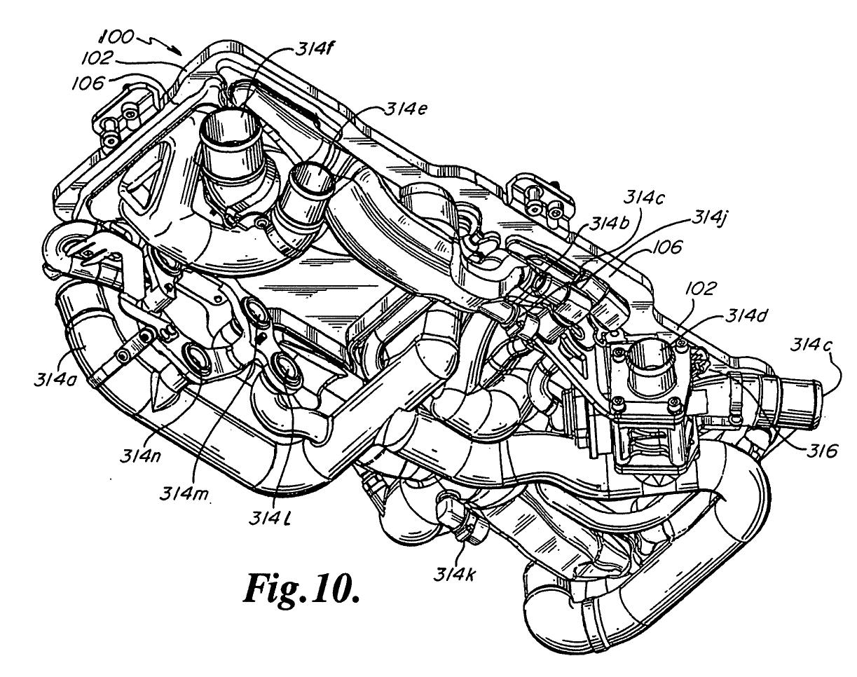

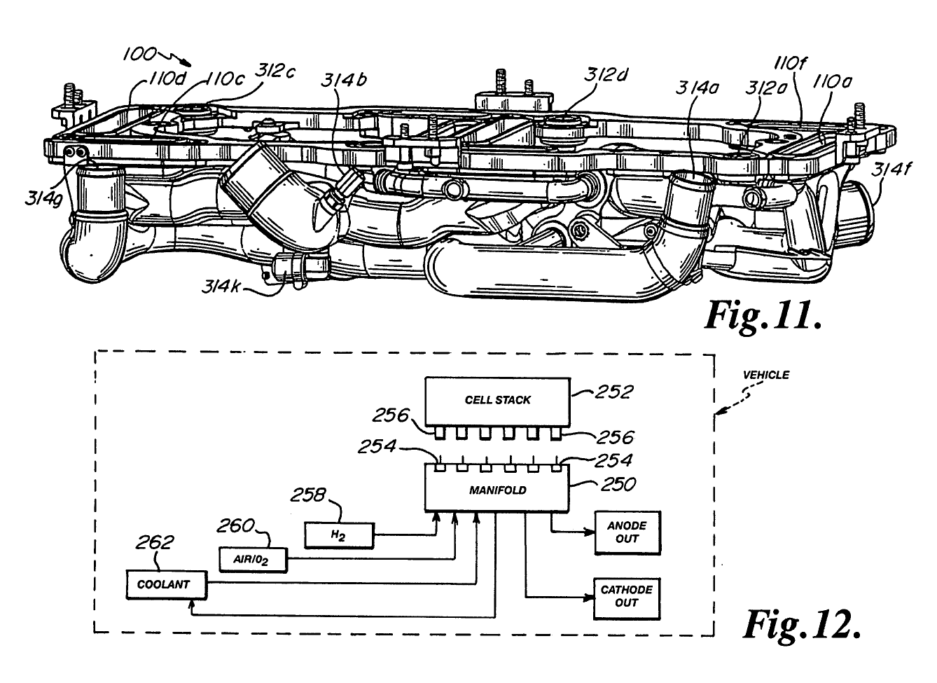

FIGS. 9-11 depict a typical manifold 100 with various ports, oval and round, and other components identified by function. The oval ports 110 include the following:
port 110a cathode in stage 1
port 110b coolant out stage 1
port 110c coolant out stage 2
port 110d cathode out stage 2
port 110e coolant in stage 2
port 110f coolant in stage 1
port 110g cathode out stage 1
port 110h cathode in stage 2
   Also included are round ports 312, including the following:
port 312a anode out stage 1
port 312b anode out stage 2
port 312c anode in stage 2
port 312d anode in stage 1
   Additionally included are hose connections 314 including the following:
314a cathode out stage 2
314b coolant out stage 2
314c cathode in stage 2
314d cathode exhaust
314e cathode in stage 1
314f coolant in stage 1
314g cathode in stage 2
314h anode in stage 1
314i anode in stage 2
314j coolant in drain
314k coolant out drain
314l anode out bleed
314m anode out stage 2
314n anode out drain
   Other components include the following:
316 electrical connection
318a DP sensor port, anode in stage 2
318b DP sensor port, anode in stage 1

Referring again to FIG. 14, the use of overmolding for a manifold port 110 is depicted. The present invention includes in one embodiment, at least one over molded port connection 110. The outer body 300 of the port 110 is preferably formed of a metal, preferably stainless steel. The inner portion 302 of the port, that portion in contact with the fluid being transported, is then formed of a material that is impervious to the fluid, preferably a plastic material such as PVDF. The plastic material is preferably injection molded around portions of the metallic body 300, as depicted at the interface 304 of the outer body 300 and the inner portion 302. All surfaces 306 that contact the fluid media are then formed of impervious plastic material, while the metallic body 300 provides the structural strength to withstand a known burst pressure (typically, 414 kpa). Further, the metallic frame 300 may be formed with integral mounting pins 308 for effecting the mating of fuel cell components.

FIG. 12 shows a schematic diagram of an electrochemical cell system comprising a manifold 250 of the present disclosure interfacing with a cell stack 252. As shown in FIG. 12, the floating ports 254 on manifold 250 can engage corresponding ports 256 on cell stack 252. Additionally, ports 254 on manifold 250 can be connected to flow tubes, such as flow tubes 152, 154, and 156, such that manifold 252 can be in fluid communication with, for example, a hydrogen source 258, an oxygen source 260 and a coolant source 262. Thus, manifold 250 can direct the flow of fluids from a plurality of fluid sources into appropriate ports 110 of cell stack 252. Manifold 250 can also direct the flow of fluids of out cell stack 252 as shown in FIG. 12. In some embodiments, the electrochemical cell of FIG. 12 can form part of an automobile or other vehicle.

The embodiments above are intended to be illustrative and not limiting. Additional embodiments are within the claims. Although the present invention has been described with reference to particular embodiments, workers skilled in the art will recognize that changes may be made in form and detail without departing from the spirit and scope of the invention.

We claim:

1. A manifold for a fuel cell, comprising:
at least one floating manifold port disposable in an oversized opening defined in a manifold frame, the manifold port being shiftable in at least one plane relative to the oversized opening for reducing the positional tolerance requirement of the manifold port, thereby effecting enhanced mating of adjacent fuel cell components.

2. The manifold of claim 1 further including at least one fluid baffle disposed in a port, the baffle acting to provide an even dispersion of fluid flow through the port.

3. The manifold of claim 2, the baffle providing for even fluid flow in a fluid flow channel across a full-length dimension of the port.

4. The manifold of claim 2, the baffle restricting fluid flow at a center portion of a fluid flow channel in favor of freer fluid flow at edge regions of the fluid flow channel.

5. The manifold of claim 1 further including at least one over molded port connection, an outer body of the port being formed of a metallic material and an inner portion of the port, the inner portion being in contact with a fluid being transported and being formed of a material that is substantially impervious to the fluid.

6. The manifold of claim 5, the material that is substantially impervious to the fluid being a plastic material, the plastic material being injection molded around portions of the metallic body.

7. The manifold of claim 5, the metallic body providing the structural strength to withstand a known burst pressure.

8. The manifold of claim 5 the metallic frame being formed with integral mounting pins for effecting the mating of fuel cell components.

9. The manifold of claim 5, the metallic frame being formed of stainless steel.

10. The manifold of claim 5, the inner portion being formed of polyvinylidine diflouride (PVDF) material.

11. The manifold of claim 1, including a manifold port rim disposable in a manifold frame groove, the manifold frame groove having an inner margin that is spaced apart from a manifold port rim outer margin.

12. The manifold of claim 1, including a plurality of snap fingers defined in a frame plate, the plurality of snap fingers being resilient and spreading responsive to insertion of a manifold channel port therein and providing float thereby, the snap fingers engaging the channel port after full insertion of the channel port therein.

13. The manifold of claim 1, including at least one pin disposed in a respective diametrically oversize bore when the manifold port is mated tot the manifold frame, the at least one pin floating in the oversize bore in at least one plane.

14. A method of forming a manifold for a fuel cell, comprising:
disposing at least one floating manifold port in an oversized opening defined in a manifold frame, effecting enhanced mating of adjacent fuel cell components by shifting the manifold port in at least one plane relative to the oversized opening and reducing the positional tolerance requirement of the manifold port thereby.

15. The method of claim 14 further including disposing at least one fluid baffle in a port and providing an even dispersion of fluid flow through the port thereby.

16. The method of claim 15, including providing for even fluid flow in a fluid flow channel across a full length dimension of the port by means of the baffle.

17. The method of claim 15, including restricting fluid flow at a center portion of a fluid flow channel in favor of freer fluid flow at edge regions of the fluid flow channel by means of the baffle.

18. The method of claim 14 further including forming an outer body of at least one port being formed of a metallic material and overmolding an inner portion of the port to a portion of the outer body, and forming the inner portion of a material that is substantially impervious to a fluid that is being transported therethrough.

19. The method of claim 18, including forming the material that is substantially impervious to a fluid that is being transported therethrough of a plastic material and injection molded the plastic material around portions of the metallic body.

20. The method of claim 18, providing a structural strength to withstand a known burst pressure by means of the metallic body.

21. The method of claim 18 including forming integral mounting pins for effecting the mating of fuel cell components with the metallic frame.

22. The method of claim 18, including forming the metallic frame of stainless steel.

23. The method of claim 18, including forming the inner portion of polyvinylidine diflouride (PVDF) material.

24. A manifold for a fuel cell including at least one fluid baffle disposed in fluid channel defined a port, the baffle acting to provide an even dispersion of fluid flow through the port.

25. The manifold of claim 24, the baffle providing for even fluid flow in the fluid flow channel across a full-length dimension of the port.

26. The manifold of claim 24, the baffle restricting fluid flow at a center portion of the fluid flow channel in favor of freer fluid flow at edge regions of the fluid flow channel.

27. A manifold for a fuel cell, including at least one over molded port connection, an outer body of the port being formed of a metallic material and having an inner portion of the port, the inner portion being in contact with a fluid being transported and being formed of a material that is substantially impervious to the fluid.

28. The manifold of claim 27, the material that is substantially impervious to the fluid being a plastic material, the plastic material being injection molded around portions of the metallic body.

29. The manifold of claim 28, the metallic body providing the structural strength to withstand a known burst pressure.

30. The manifold of claim 28 the metallic frame being formed with integral mounting pins for effecting the mating of fuel cell components.

31. The manifold of claim 28, the metallic frame being formed of stainless steel.

32. The manifold of claim 28, the inner portion being formed of polyvinylidine diflouride (PVDF) material.
